(19) United States
(12) Patent Application Publication
(10) Pub. No.: US 2018/0060676 A1
(43) Pub. Date: Mar. 1, 2018

(54) METHOD AND DEVICE FOR DETECTING AND EVALUATING ENVIRONMENTAL INFLUENCES AND ROAD CONDITION INFORMATION IN THE VEHICLE SURROUNDINGS

(71) Applicant: Continental Teves AG & Co. oHG, Frankfurt (DE)

(72) Inventors: Bernd Hartmann, Bad Homburg (DE); Sighard Schräbler, Karben (DE); Manuel Amthor, Jena (DE); Joachim Denzler, Jena (DE)

(73) Assignee: Continental Teves AG & Co. oHG, Frankfurt (DE)

(21) Appl. No.: 15/802,868

(22) Filed: Nov. 3, 2017

Related U.S. Application Data
(63) Continuation of application No. PCT/DE2016/200208, filed on May 4, 2016.

(30) Foreign Application Priority Data
May 6, 2015 (DE) 10 2015 208 428.0

(51) Int. Cl. G06K 9/00; B60W 40/06; G06K 9/62

(52) U.S. Cl. CPC G06K 9/00791; B60W 40/06; G06T 2207/30256; G06K 9/6267; B60W 2550/14; G06K 9/00805

(57) ABSTRACT

A method for detecting and evaluating environmental influences and road condition information in the surroundings of a vehicle. At least two digital images are generated in a successive manner using a camera, and the same image section is selected on each image. Changes in the image sharpness between the image sections of the at least two successive images are detected using digital image processing algorithms, wherein the image sharpness changes are weighted in a decreasing manner from the center of the image sections towards the outside. Surroundings condition information is ascertained on the basis of the detected image sharpness changes between the image sections of the at least two successive images using machine learning methods, and road condition information is determined on the basis of the ascertained surroundings condition information.

### CROSS-REFERENCE TO RELATED APPLICATIONS

This application claims the benefit of PCT Application PCT/DE2016/200208, filed May 4, 2016, which claims priority to German Patent Application 10 2015 208 428.0, filed May 6, 2015. The disclosures of the above applications are incorporated herein by reference.

### FIELD OF THE INVENTION

The invention relates to a method for detecting and evaluating environmental influences in the surroundings of a vehicle. The invention further relates to a device for carrying out the aforementioned method and to a vehicle comprising such a device.

### BACKGROUND OF THE INVENTION

Technological progress in the field of optical image acquisition allows the use of camera-based driver assistance systems which are located behind the windshield and capture the area in front of the vehicle in the way the driver perceives it. The functionality of these systems ranges from automatic headlights to the detection and display of speed limits, lane departure warnings, and imminent collision warnings.

Starting from just capturing the area in front of the vehicle to a full 360° panoramic view, cameras may now be found in various applications and different functions for driver assistance systems in modern vehicles. It is the primary task of digital image processing as a standalone function or in conjunction with radar or lidar sensors to detect, classify, and track objects in the image section. Classic objects typically include various vehicles such as cars, trucks, two-wheel vehicles, or pedestrians. In addition, cameras detect traffic signs, lane markings, guardrails, free spaces, or other generic objects.

Automatic learning and detection of object categories and their instances is one of the most important tasks of digital image processing and represents the current state of the art. Due to the methods which are now very advanced and which may perform these tasks almost as well as a person, the focus has now shifted from a coarse localization to a precise localization of the objects.

Modern driver assistance systems use different sensors including video cameras to capture the vehicle surroundings as accurately and robustly as possible. This environmental information, together with driving dynamics information from the vehicle (e.g. from inertia sensors) provide a good impression of the current driving state of the vehicle and the entire driving situation. This information is used to derive the criticality of driving situations and to initiate the respective driver information/alerts or driving dynamic interventions through the brake and steering system.

However, since the available friction coefficient or road condition is not provided or cannot be designated in driver assistance systems, the times for issuing an alert or for intervention are in principle designed based on a dry road with a high adhesion coefficient between the tire and the road surface.

In the case of accident-preventing or impact-weakening systems, the driver is alerted or the system intervenes so late that—in accordance with the system design which has the conflicting goals of alerting the driver in good time but without issuing erroneous alerts too early—accidents do manage to be prevented or accident impacts acceptably weakened if the road is in fact dry. If, however, the road provides less adhesion due to moisture, snow, or even ice, an accident may no longer be prevented and the reduction of the impact of the accident does not have the desired effect.

DE 10 2006 016 774 A1 discloses a rain sensor which is arranged in a vehicle. The rain sensor comprises a camera and a processor. The camera takes an image of a scene outside of the vehicle through a windshield of the vehicle with an infinite focal length. The processor detects rain based on a variation degree of intensities of pixels in the image from an average intensity of pixels.

### SUMMARY OF THE INVENTION

It is therefore be the object of the present invention to provide a method and a device of the type indicated above, with which the road condition or even the available friction coefficient of the road may be determined or at least estimated by the system so that driver alerts as well as system interventions may accordingly be effected in a more targeted manner and, as a result, the effectiveness of accident-preventing driver assistance systems is increased.

The object is achieved by the subject matter of the independent claims. Preferred embodiments are the subject matter of the subordinate claims.

The method according to the invention for detecting and evaluating environmental influences in the surroundings of a vehicle according to claim 1 comprises the method steps of
providing a camera in the vehicle,
generating at least two digital images in a successive manner by using the camera,
selecting the same image section on the two images,
detecting changes in the image sharpness between the image sections using digital image processing algorithms, wherein the image sharpness changes are weighted from the center of the image sections towards the outside,
ascertaining surroundings condition information on the basis of the detected image sharpness changes between the image sections using machine learning methods, and
determining road condition information on the basis of the ascertained surroundings condition information.

In accordance with the method according to the invention, a search is made for specific features in the images generated by the camera by using digital image processing algorithms, which features make it possible to draw conclusions about environmental conditions in the surroundings of the vehicle and, therefore, about the current road condition. In this case, the selected image section represents the so-called “region of interest (ROI)” which will be assessed. Features which are suitable for capturing the different appearance of the surroundings in the images of the camera on the basis of the presence of such environmental influences or environmental conditions respectively may be extracted from the ROI. It is advantageously envisaged in connection with this that features which capture the image sharpness change between the image sections of the at least two successive images are extracted, a feature vector is formed from the extracted features and the feature vector is assigned to a class through the use of a classifier.

The method according to the invention uses digital image processing algorithms with the aim of detecting and evaluating environmental influences in the immediate surroundings of a vehicle. Environmental influences such as, for example, rain, heavy rain or snowfall but also the consequences thereof such as splashing water, water droplets or even snow trails of the ego-vehicle but also of other vehicles driving in front or driving to the side may be detected or identified, from which relevant surroundings condition information may be ascertained. The method is characterized in particular in that the temporal context is incorporated by a sequence of at least two images and thus the feature space is extended by the temporal dimension. The decision regarding the presence of environmental influences and/or the resulting effects is therefore not made with reference to absolute values, which in particular prevents erroneous classifications if the image is not very sharp, e.g. in the event of heavy rain or fog.

The method according to the invention is preferably used in a vehicle. The camera may, in this case, in particular be provided inside the vehicle, preferably behind the windshield, so that the area in front of the vehicle is captured in the way the driver of the vehicle perceives it.

A digital camera is preferably provided, with which the at least two images are directly digitally recorded and assessed using digital image processing algorithms. In particular, a mono camera or a stereo camera is used to generate the images since, depending on the characteristic, depth information from the image may also be used for the algorithm.

The method is particularly robust since the temporal context is incorporated. It is assumed that a sequence of successive images has little change in the image sharpness in the scene, and considerable changes in the calculated feature values are caused by impinging and/or disappearing environmental influences (for example raindrops or splashing water, spray mist, spray). This information is used as a further feature. In this case, the sudden change in individual image features of successive images is of interest and not the entire change within the sequence, e.g. tunnel entrances or objects moving past.

In order to robustly remove unwanted sudden changes in the edge region of the images, in particular in the lateral edge region of the images, the calculation of individual image features is weighted in a descending manner from the inside to the outside. In other words: changes in the center of the selected region have a greater weighting than changes which occur at a distance from the center. A sudden change, which, if at all possible, should not find its way at all, or should only find its way in a subordinate manner, into the ascertainment of the surroundings condition information, may be caused, for example, by a vehicle passing to the side.

The individual features form a feature vector which combines the various information from the ROI to make it possible, during the classification step, to make a more robust and more accurate decision about the presence of such environmental influences. Different types of features produce a good many feature vectors. The good many feature vectors thus produced are referred to as a feature descriptor. The feature descriptor is composed by a simple concatenation, weighted combination, or other non-linear mappings. The feature descriptor is subsequently assigned to at least one surroundings condition class by a classification system (classifier). These surroundings condition classes are, for example, “environmental influences yes/no” or “(heavy) rain” and “remainder”.

A classifier is a mapping of the feature descriptor on a discrete number that represents the classes to be detected. A random decision forest is preferably used as a classifier. Decision trees are hierarchical classifiers which break down the classification problem iteratively. Starting at the root, a path towards a leaf node where the final classification decision is made is followed based on previous decisions. Due to the learning complexity, very simple classifiers, so-called decision stumps, which separate the input parameter space orthogonally to a coordinate axis, are preferred for the inner nodes.

Decision forests are collections of decision trees which contain randomized elements preferably at two points in the training of the trees. First, every tree is trained with a random selection of training data, and second, only one random selection of permissible dimensions is used for each binary decision. Class histograms are stored in the leaf nodes which allow a maximum likelihood estimation with respect to the feature vectors that reach the leaf node during the training. Class histograms store the frequency with which a feature descriptor of a specific item of information about an environmental influence reaches the respective leaf node while traveling through the decision tree. As a result, each class may preferably be assigned a probability that is calculated from the class histograms.

To make a decision about the presence of such environmental influences for a feature descriptor, the most probable class from the class histogram is preferably used as the current condition, or other methods may be used, to transfer information from the decision trees, for example, into a decision about the presence of rain or a different environmental influence decision.

An optimization step may follow this decision per input image. This optimization may take the temporal context or further information which is provided by the vehicle into account. The temporal context is preferably taken into account by using the most frequent class from a previous time period or by calculating the most frequent class using a so-called hysteresis threshold value method. The hysteresis threshold value method uses threshold values to control the change from one road condition into another. A change is made only when the probability of the new condition is high enough and the probability of the old condition is accordingly low.

According to a preferred embodiment, the image section may advantageously be a central image section which preferably comprises a center image section around the optical vanishing point of the images. This central image section is preferably oriented in a forward-looking manner in the vehicle direction of travel and forms the ROI. The advantage of selecting such a center image section is that disruptions during detection of changes in the region are kept particularly low, in particular because the lateral region of the vehicle is taken very little account of during movement in a straight line. In other words, this embodiment is in particular characterized in that, for the purposes of judging weather-related environmental influences or environmental conditions respectively such as, for example, rain, heavy rain or fog, the largest possible center image section around the optical vanishing point is enlisted. In this case, in a particularly advantageous form, the influence of the pixels located therein—in particular normally distributed (see below)—are weighted in a descending manner from the inside towards the outside, in order to further increase the robustness with respect to peripheral appearances such as, for example, objects moving past quickly or the infrastructure.

The image section may, according to another preferred embodiment, advantageously also comprise a detected moving obstacle, e.g. may be focused on a vehicle or a two-wheel vehicle, in order to detect in the immediate surroundings—in particular in the lower region of these objects—indicators of splashing water, spray, spray mist, snow banners etc. The moving obstacles each form a ROI. In other words, for the purpose of judging effects of weather-related environmental influences (e.g. splashing water, spray, spray mist and snow banners) dedicated image sections are enlisted, which are determined with reference to available object hypotheses—preferably vehicles driving in front or to the side.

The weighting is realized with various approaches such as e.g. the exclusive observation of the vanishing point in the image or the observation of a moving vehicle. Furthermore, image sharpness changes between the image sections of the at least two successive images may also be advantageously weighted in a decreasing manner from the inside towards the outside in accordance with a Gaussian function with a normally distributed weighting. In particular, it is therefore envisaged that a normally distributed weighting is carried out around the vanishing point of the center image section or around the moving obstacle. The advantage of this, in particular, is that a temporal movement pattern of individual image regions are taken into account by the algorithm.

Changes in the image sharpness between the at least two image sections are detected with reference to a calculation of the change in the image sharpness within the image section. This exploits the fact that impinging, unfocused raindrops in the observed region change the sharpness in the camera image. The same applies to detected moving objects in the immediate surroundings, the appearance of which—in particular image sharpness—changes in the event of rain, splashing water, spray or snow banners in the temporal context. In order to be able to make a statement about the presence of specific environmental influences or environmental conditions respectively or the resulting effects, features are extracted on the basis of the calculated image sharpness—preferably using statistical moments, in order to subsequently carry out a classification—preferably “random decision forests”—with reference to the ascertained features.

The image sharpness is calculated with the aid of numerous methods, preferably on the basis of homomorphic filtering. The homomorphic filtering provides reflection quotas as a measure of the sharpness irrespective of the illumination in the image. Furthermore, the required Gaussian filtering is approximated and, as a result, the required computing time may be reduced with the aid of repeated application of a median filter.

The sharpness calculation takes place on different image representations (RGB, lab, grayscale, etc.), preferably on HSI channels. The values thus calculated, as well as the mean thereof and variance are used as individual image features.

Another preferred embodiment of the method according to the invention comprises the additional method steps: communicating the surroundings condition and/or road condition information, which has previously been ascertained with reference to the surroundings condition information, to a driver assistance system of a vehicle and adjusting times for issuing an alert or for intervention using the driver assistance system on the basis of the surroundings condition and/or road condition information. In this way, the road condition information is used as an input for the accident-preventing driver assistance system, e.g. for an autonomous emergency brake (AEB) function, in order to be able to adjust the times for issuing an alert or for intervention of the driver assistance system accordingly in a particularly effective manner. The effectiveness of accident-preventing measures using such so-called advanced Driver Assistance Systems (ADAS) may, as a result, be significantly increased.

Furthermore, the following method steps are advantageously provided:
incorporating the surroundings condition and/or road condition information into the function of an automated vehicle, and
adjusting the driving strategy and determining handover times between the automated system and the driver on the basis of the surroundings condition and/or road condition information.

The device according to the invention for carrying out the method described above comprises a camera which is set up to generate at least two successive images. The device is, furthermore, set up to select the same image section on the at least two images, to detect changes in the image sharpness between the at least two image sections using digital image processing algorithms and, in the process, to weight the image sharpness changes in a decreasing manner from the center of the image sections towards the outside, to ascertain surroundings condition information on the basis of the detected changes in the image sharpness between the image sections using machine learning methods, and to determine road condition information on the basis of the ascertained surroundings condition information.

With regard to the advantages and advantageous embodiments of the device according to the invention, reference is made to the foregoing explanations in connection with the method according to the invention in order to avoid repetitions, wherein the device according to the invention may have the necessary elements for this or may be set up for this in an extended manner.

The vehicle according to the invention comprises a device according to the invention as described above.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

Embodiment examples of the invention will be explained in more detail below with reference to the drawing, wherein:

FIG. 1 shows a representation of calculated image sharpnesses for a central image section, and

FIG. 2 shows a representation of calculated image sharpnesses for a dedicated image section.

### DETAILED DESCRIPTION OF THE PREFERRED EMBODIMENTS

The following description of the preferred embodiment(s) is merely exemplary in nature and is in no way intended to limit the invention, its application, or uses.

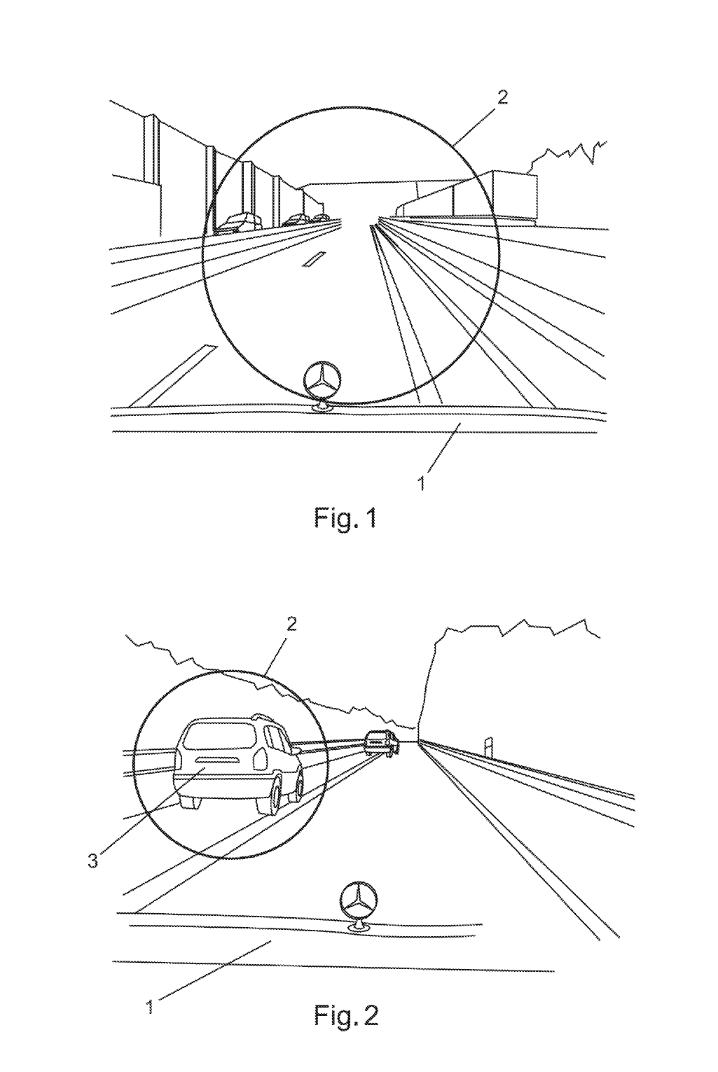

FIGS. 1 and 2 each show a representation of calculated image sharpnesses for a central image section (FIG. 1) or a dedicated image section (FIG. 2) according to two embodiment examples of the method according to the invention. FIGS. 1 and 2 respectively show the front part of an embodiment example of a vehicle 1 according to the invention, which vehicle is equipped with an embodiment example of a device according to the invention (not shown) which comprises a camera. The camera is provided inside the vehicle behind the windshield, so that the area in front of the vehicle 1 is captured in the way the driver of the vehicle 1 perceives it. The camera has generated two digital images in a successive manner and the device has selected the same image section 2, which is respectively outlined with a circle in FIGS. 1 and 2, in both images, and changes in the image sharpness between the image sections 2 are detected using digital image processing algorithms. In the embodiment examples shown, the image sharpness for the image sections 2 was calculated on the basis of the homomorphic filtering, the result of which is shown by FIGS. 1 and 2.

In this case, the image section 2 according to FIG. 1 is a central image section which comprises a center image section around the optical vanishing point of the images. This central image section 2 is directed in a forward-looking manner in the vehicle direction of travel and forms the region of interest. The image section according to FIG. 2, on the other hand, includes a detected moving obstacle and is, in this case, focused on another vehicle 3, in order to detect in the immediate surroundings—in particular in the lower region of the other vehicle 3—indicators of splashing water, spray, spray mist, snow banners etc. The other moving vehicle 3 forms the region of interest.

Changes in the image sharpness between the image sections 2 are weighted in a decreasing manner from the inside towards the outside in accordance with a Gaussian function, i.e. normally distributed. In other words, changes in the center of the image sections 2 have the greatest weighting and changes in the edge region are only taken into account to an extremely low degree during the comparison of the image sections 2.

In the examples shown by FIGS. 1 and 2, the device detects that only slight changes in the image sharpness are present between the image sections, and ascertains surroundings condition information, including the fact that no rain, splashing water, spray or snow banners are present, from this. The surroundings condition information is, in this case, ascertained using machine learning methods and not by manual inputs. An appropriate classification system is, in this case, supplied with data from the changes in the image sharpness of at least 2 images, but preferably from several images. In this case, the relevant factor is not only how large the change is, but how the change alters in the temporal context. And it is precisely this course which is learnt here and rediscovered in subsequent recordings. It is not known exactly what this course must look like, in order to be dry for example. This information is almost concealed in the classifier and may only be predicted with difficulty, if at all.

The device furthermore ascertains road condition information, including the fact that the road is dry, from the ascertained surroundings condition. The road condition information is communicated to a driver assistance system of the vehicle (not shown), which, in this case, refrains from adjusting times for issuing an alert or for intervention on the basis of the road condition information.

In the alternative case that major deviations are detected between the image sections, the device would ascertain surroundings condition information, including the fact that e.g. rain is present, from this. The device would then ascertain road condition information, including the fact that the road is wet, from the ascertained surroundings condition information. The road condition information would then be communicated to the driver assistance system of the vehicle, which would then adjust times for issuing an alert or for intervention on the basis of the road condition information.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method for detecting and evaluating environmental influences and road condition information in the surroundings of a vehicle, comprising the steps of:
providing a camera in the vehicle;
generating at least two digital images in a successive manner utilizing the camera;
selecting at least two image sections from the at least two digital images;
detecting changes in the image sharpness between the at least two image sections using digital image processing algorithms, such that the image sharpness changes are weighted in a decreasing manner from the center of each of the at least two image sections towards the outside of the at least two image sections;
ascertaining surroundings condition information on the basis of the detected changes in the image sharpness between the at least two image sections using machine learning methods; and
determining road condition information on the basis of the ascertained surroundings condition information;
calculating the change in the image sharpness between the at least two image sections of the at least two digital images on the basis of homomorphic filtering.

2. The method of 1, further comprising the steps of providing that each of the at least two image sections is a central image section around the optical vanishing point.

3. The method of claim 2, further comprising the steps of:
providing at least one obstacle;
detecting the at least one obstacle in at least one of the at least two image sections.

4. The method of claim 1, further comprising the steps of weighting the changes in the image sharpness between the at least two image sections of the at least two digital images in a descending manner from the inside towards the outside in accordance with a Gaussian function.

5. The method of claim 1, further comprising the steps of:
providing a classifier;
extracting features which capture the changes in the image sharpness between the at least two image sections of the at least two digital images;
forming a feature vector from the extracted features; and
assigning the feature vector to a class using the classifier.

6. The method of claim 1, further comprising the steps of:
providing a driver assistance system for a vehicle;
communicating at least one of the surroundings condition information or road condition information to the driver assistance system of a vehicle; and
adjusting the times for issuing an alert or for intervention using the driver assistance system on the basis of at least one of the surroundings condition information or road condition information.

7. The method of claim 1, further comprising the steps of:
providing an automated vehicle having an automated system;
incorporating at least one of the surroundings condition information or road condition information into the function of the automated vehicle;
adjusting the driving strategy on the basis of at least one of the surroundings condition information or road condition information;
determining handover times between the automated system and the driver on the basis of at least one of the surroundings condition information or road condition information.

8. A device for detecting and evaluating environmental influences and road condition information in the surroundings of a vehicle, comprising:
a camera which is set up to generate at least two successive images;
the camera being configured to:
select the same image section on the at least two successive images;
detect changes in the image sharpness between the at least two image sections using digital image processing algorithms and, in the process, to carry out a weighting of the image sharpness changes in a decreasing manner from the center of the image sections towards the outside;
ascertain surroundings condition information on the basis of the detected image sharpness changes using machine learning methods;
determine road condition information on the basis of the ascertained surroundings condition information;
wherein the change in the image sharpness between the image sections of the at least two successive images is calculated on the basis of homomorphic filtering.

9. A vehicle comprising:
a device for detecting and evaluating environmental influences and road condition information in the surroundings of a vehicle:
a camera which is set up to generate at least two successive images, the camera being part of the device;
the camera being configured to:
select the same image section on the at least two successive images;
detect changes in the image sharpness between the at least two image sections using digital image processing algorithms and, in the process, to carry out a weighting of the image sharpness changes in a decreasing manner from the center of the image sections towards the outside;
ascertain surroundings condition information on the basis of the detected image sharpness changes using machine learning methods;
determine road condition information on the basis of the ascertained surroundings condition information;
wherein the change in the image sharpness between the image sections of the at least two successive images is calculated on the basis of homomorphic filtering.
